(19) United States
(12) Patent Application Publication
(10) Pub. No.: US 2010/0021790 A1
(43) Pub. Date: Jan. 28, 2010

(54) Elastomeric bipolar plates

(75) Inventors: Ismat Abu-Isa, Rochester Hills, MI (US); Xia Wang, Rochester Hills, MI (US); Gary Barber, Novi, MI (US); Elaine Petrach, Troy, MI (US)

Correspondence Address: Ian C. McLeod;BUTZEL LONG, 2190 Commons Parkway, Okemos, MI, 48864, US

(73) Assignee: Oakland University, Rochester, MI (US)

(21) Appl. No.: 12/455,189

(22) Filed: May 29, 2009

Related U.S. Application Data
(60) Provisional application No. 61/130,613, filed on May 30, 2008.

(51) Int. Cl. H01M 8/10

(52) U.S. Cl. 429/33

(57) ABSTRACT

An elastomeric conductive bipolar plate for use in proton exchange membrane fuel cells is described. The plate reduces the weight of the fuel cell and eliminates the need for gaskets typically used in these fuel cells.

### CROSS-REFERENCE TO RELATED APPLICATIONS

This application claims benefit to U.S. Provisional Application Ser. No. 61/130,613, filed May 30, 2008, which is incorporated herein by reference in its entirety.

### STATEMENT REGARDING FEDERALLY SPONSORED RESEARCH OR DEVELOPMENT

Not Applicable.

### STATEMENT REGARDING GOVERNMENT RIGHTS

Not Applicable.

### BACKGROUND OF THE INVENTION

(1) Field of the Invention

The present invention relates to elastomeric conductive composite materials used to provide bipolar plates, without a gasket, in a proton exchange membrane (PEM) cell. In particular, the present bipolar plates are used to contain fuel cell reactant fluids and reaction byproducts.

(2) Description of Related Art

Bipolar plates are traditionally made either of a metal or graphite. The main disadvantage of using metal plates is potential corrosion as a result of interactions with the fuel cell medium. Graphite does not exhibit corrosion in fuel cell medium but it has the disadvantages of expensive manufacturing, and brittleness. The bipolar plates made of graphite have to be thick in order to avoid breaking when pressure is applied to them in order to establish good cell-to-cell contact in a fuel stack. This leads to an undesirable heavy volume of the stack.

For these reasons more emphasis has been placed on organic composites in recent years. Organic composites consist of a matrix material that is either a thermoset or thermoplastic that is combined with non-corrosive conductive filler. The use of organic composites overcomes most of the disadvantages seen when using graphite or metal, including more efficient processing for bipolar plates, improved mechanical properties and corrosion resistance. Organic composites developed for bipolar plate applications include thermoset composites based on vinyl ester [1,2], and phenolic resin [3,4], and composites based on thermoplastic resins including polypropylene [4,5], polyethylene [6], polyester [7,8], polyphenylene sulfide [5,8], polycarbonate [9,10] and polyvinylidene fluoride (PVDF)[6,11]. None of the composites discussed in the literature are based on elastomeric materials. The disadvantage of using above composites with plastics is that the resulting materials have high stiffness and require use of elastomeric gaskets for sealing, and high compression stress to insure good electrical contact resistance.

### OBJECTS

There is a need for a new type of bipolar plate which reduces the weight, volume and cost of the fuel cell and eliminates the need for a gasket to mount the plate(s) where usually there are one on each side of the fuel cell. It is further an object of the present invention to provide a bipolar plate which is economical to produce and light weight. These and other objects will become increasingly apparent by reference to the following description.

### SUMMARY OF THE INVENTION

The present invention relates to an elastomeric highly conductive composite of an elastomeric matrix and conductive fillers for use as bipolar plates for a proton exchange membrane (PEM) fuel cell, and which function to manage the flow of reactant gases through the fuel cells, wherein the elastomeric bipolar plates provide sealing to contain fuel cell reactant fluids and reaction by-products without the need for additional gaskets and low contact electrical resistance. Preferably, the elastomeric matrix is silicone rubber with silica filler. In further embodiments, the conductive filler is selected from the group consisting of graphite fiber, natural graphite flakes, synthetic graphite flakes, graphite powder, and mixtures thereof. In further still embodiments, 15 to 60 volume percent conductive filler is uniformly distributed in the elastomeric matrix. In further still embodiments, the present disclosure comprises between 25 to 40 volume percent conductive filler and 60 to 75 volume percent silicone rubber matrix. In further embodiments, the conductive filler is a blend of a graphite fiber and graphite flake. In further still embodiments, the composite comprises graphite fiber and graphite flake providing improved electrical resistivity over the fiber or flake alone. In still further embodiments, the conductive filler concentration is between 15 to 60% volume percent. In further still embodiments, the conductive filler is between 20 and 35 volume percent. In still further embodiments, the silicone matrix content is between 60 and 75% by volume.

The present invention relates to a proton exchange membrane (PEM) fuel cell assembly which comprises bipolar plates for the fuel cell, the plates comprising 15 to 60 volume percent conductive filler, comprising carbon based fibers, carbon based flakes, or a mixture of carbon based fibers and carbon based flakes and the balance an elastomeric matrix. Preferably, the assembly comprises 60 to 80 volume percent of the matrix for the filler which is homogeneously dispersed throughout the matrix. In further still embodiments, the matrix is a silicone elastomer, so that the plate is elastic. In further still embodiments, the volume percent of the conductive filler is 20 to 40 volume percent. In further still embodiments, the matrix contains a non conductive filler in an amount of 35% by volume. In still further embodiments, the matrix contains silica as a filler in an amount of 35% by volume. In further still embodiments, a porous heat sink is provided on the bipolar plate to dissipate heat.

### BRIEF DESCRIPTION OF THE DRAWINGS

FIG. 1 is a perspective view of a fuel cell of the present invention. FIG. 1A is a separated view showing detail of the bipolar plate in the fuel cell.

FIG. 2 is a perspective experimental schematic view of the Four-Point Probe Resistivity Setup.

FIG. 3 is a graph showing Santoprene Resistivity as a Function of Volume % of Graphite DKD.

FIG. 4 is a graph showing resistivity of silicone/graphite fiber composites employing short (DKD) fibers & long (CKD) graphite fibers and blends of both fibers.

FIG. 5 is a graph showing silicone composite resistivity versus percent volume of conductive fillers.

FIG. 6 is a graph showing effect of blended graphite grades on resistivity of a composite containing 35 volume percent filler and 65 volume percent silicone.

FIG. 7 is a graph showing stress strain cycle of a composite containing 60/40 (by volume) silicone rubber matrix/graphite fiber composite during stress loading/unloading cycle.

FIG. 8 is a flow diagram for the production of the bipolar plates.

FIG. 9 is a linear conduction apparatus schematic to measure thermal conductivity.

FIG. 10 is a graph showing electrical resistivities of composites containing a 35% by Volume of Blended DKD/4012.

FIG. 11 is a graph showing thermal conductivities relative to conductive filler volume percentages.

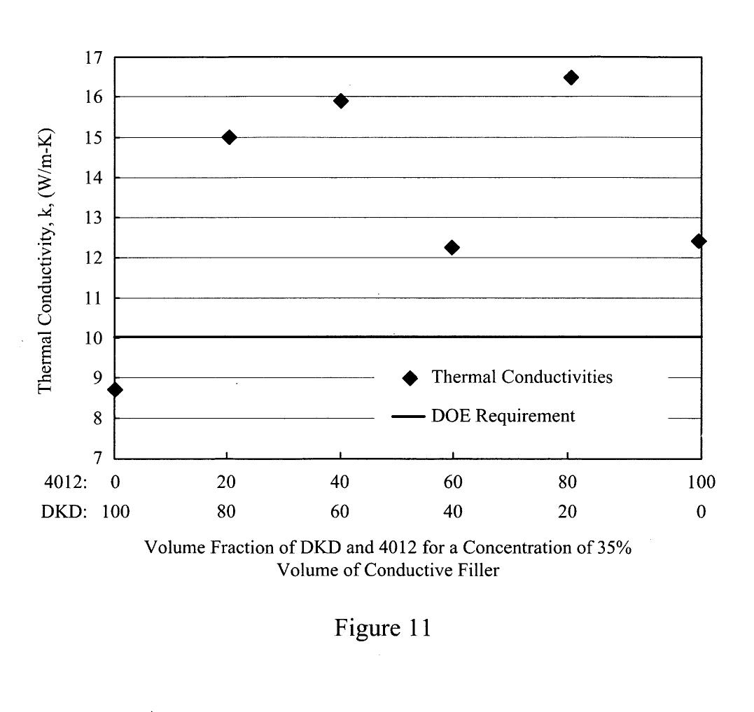

FIG. 12 is a graph showing stress-strain relationship of loading and unloading cycles for DKD-4012-RTV 627 composition consisting of 28-7-65% volume.

FIG. 13 is a schematic showing a three layer elastomeric composite bipolar plate.

### DESCRIPTION OF PREFERRED EMBODIMENTS

The publications cited herein are incorporated herein in their entireties. In particular, they show the development of bipolar plates.

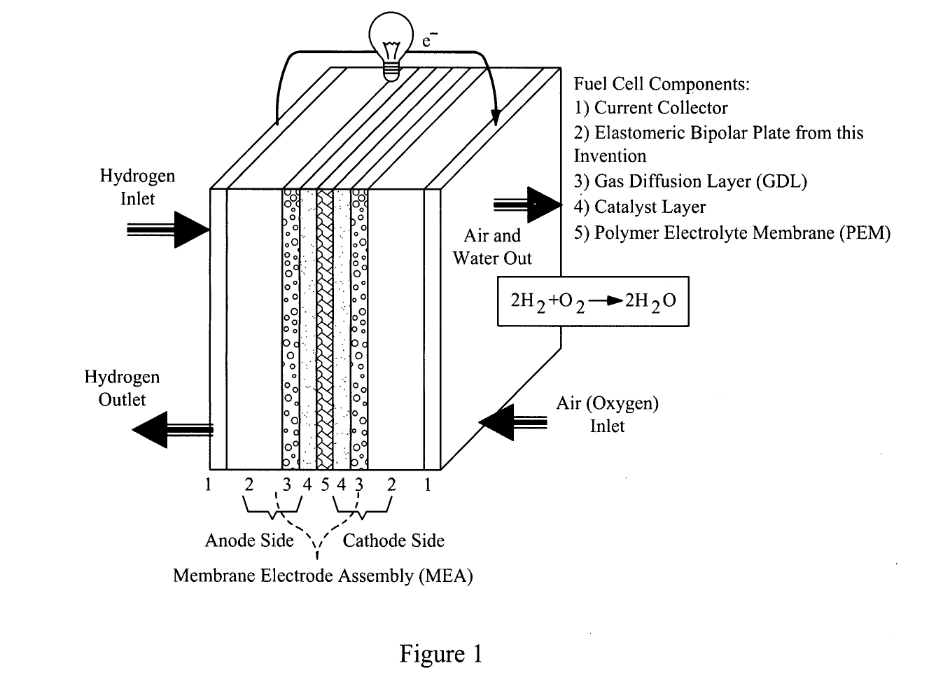

The preferred fuel cell of the present invention is shown as FIGS. 1 and 1A. The present invention uses soft elastomeric materials which have the advantages of the above plastic composite bipolar plates, but in addition they provide good sealing for containment of fuel cell reactants and reaction products without the need for additional gaskets. The other advantage is the expected low contact resistance attributed to the elastic nature of the materials and the ease of solid flow to accommodate whatever surface imperfection is present in the mating surface, thus leading to good contact.

The present invention is based on the fact that we were able to develop highly conductive elastomeric composite at relatively low conductive filler ratio. The bipolar plate materials thus have the required elasticity for good sealing and high conductivity for making efficient bipolar plates. The other advantage of this invention is that the developed material is easily processable because it does not contain high filler concentration that hinders flow during the forming of bipolar plates.

### EXAMPLES

In the search for materials, two elastomers were investigated that meet the envisioned properties. The first is a two component polymer liquid silicone rubber (GE Silicones, RTV 627A and B), and the second is a solid polyolefin thermoplastic elastomer (Santoprene TPV 8201-60). For both polymers a number of other grades made by different suppliers could have been used. The mechanical, electrical and thermal properties of these two types of elastomers are shown in Table 1.

TABLE 1
Properties of Investigated Elastomers

| Property | Silicone[12] | Santoprene[14] |
|---|---|---|
| Density (g/cm³) | 1.37 | 0.95 |
| Electrical Resistivity(Ω-cm) | 5.7 × 10¹⁴ | — |
| Thermal Conductivity (W/m-K) | 0.31 | 0.12 |
| Hardness, Shore A | 62 | 60 |
| Tensile Strength (MPa) | 3.24 | 5.9 |
| Tear Strength (kN/m) | 3.33 | 32 |
| Operating Temperature range (° C.) | −60 to 204 | −60 to 135 |

The silicone elastomer is composed of vinyl polydimethyl siloxane and contains dimethylhydrogen siloxane as curing agent. The two component polymer can be cured either at room temperature, or higher temperature for faster curing time. The polymer has exceptional thermal stability, a wide range of usage temperature, and shows very little degradation under exposure to fuel cell reactant gases. The silicone elastomer comprises about 35% by volume of silica. Silica particle size is between 3 to 40 millimicrons.

The dynamically vulcanized polyolefin thermoplastic elastomer (Santoprene TPV 8201-60) is a two phase solid polymer consisting of a lightly vulcanized ethylene-propylene rubber phase dispersed in a thermoplastic polypropylene matrix. The polymer has good thermal, UV, oxidative, and water resistance, providing ideal conditions for use in PEM fuel cells. As a thermoplastic elastomer the material can be processed using conventional plastic techniques [13], including extrusion and injection molding. Mechanical and thermal properties of the polymer are also shown in Table 1 [14].

The elastomer can contain 10 to 40% by volume of a finely divided non conductive filler, like silica. Preferably, the volume is 35%. Various non conductive fillers are well known in the art.

The polymer matrix materials are made electrically conductive by the addition of conductive fillers including thermal graphite fibers (Cytec DKD & CKD, CYTEC Industries, NJ), a graphite fiber made from polyacrylonitrile (PAN, AGM 99), high surface area conductive carbon black nanoparticles (Cabot Black Pearls 2000, Cabot Corporation, MA), natural graphite flakes (Asbury 3061 and 3763, Asbury Carbons, NJ), synthetic graphite flake (Asbury 4012), thermally conductive graphite powders (Asbury TC 301, 303, 304, 305), and surface enhanced graphite (Asbury 3775). The properties of all these conductive fillers are shown in Table 2 along with their suppliers.

TABLE 2
Type and Properties of Conductive
Fillers Investigated and Their Suppliers

| | Cytec | Carbon | Asbury Graphite | | | | |
|---|---|---|---|---|---|---|---|
| | Graphite | Black | [17] | | | | |
| | Fibers | Nanoparticle | Fiber | | | Surface | |
| Property | [25] | [15, 16] | AGM | Synthetic | TC | Enhanced | Natural |
| | CKD | Printex XE 2 | 99 | 4012 | 301 | 3775 | 3061 |
| | DKD | Black Pearls | | | 303 | | 3763 |
| | | 2000 | | | 304 | | |
| | | Vulcan | | | 305 | | |
| | | XC-72 | | | | | |
| Density | 2.2 | 1.8 | 2.23 | 2.23 | 2.23 | 2.23 | 2.275 |
| (g/cm³) | | | | | | | |
| Electrical | <0.0003 | — | 0.13 | 0.03 | 0.04 | 0.04 | 0.03 |
| Resistivity | | 0.0014[18] | | | 0.05 | | |
| (Ω-cm) | | 0.37[19] | | | 0.04 | | |
| | | | | | 0.02 | | |
| Thermal | 400-700 | — | — | — | — | — | — |
| Conductivity | | | | | | | |
| (w/m-K) | | | | | | | |
| Additive | Fiber | Particulate | Fiber | Flake | Powder | Flake | Flake |
| Shape | | | | | | | |
| Diameter | 10 | 0.025 | | 50-800 | — | — | — |
| (μm) | | 0.012 | | | — | | — |
| | | 0.029 | | | — | | |
| Length (μm) | 1 × 10⁶ | | 150 | 150 | 8 | 300 | 500 |
| | 200 | | | | 16 | | 8 |
| | | | | | 35 | | |
| | | | | | 300 | | |
| Surface Area | 0.4 | 950 | 1.87 | 1.5 | 11.64 | 23.7 | 0.99 |
| (m²/g) | | 1450 | | | 6.7 | | 2 |
| | | 180 | | | 5.3 | | |
| | | | | | 1.59 | | |

### Processing

Two methods were used for processing & molding samples of conductive composites based on silicone liquid elastomer and Santoprene solid thermoplastic olefin elastomer. In case of the liquid silicone matrix GE RTV(MOMENTIVE) 627A and B the two polymer components were first mixed either by hand or in some cases using an electric blender. The conductive additives were then incorporated and mixed with the elastomer matrix to form slurry. A weighed amount of the slurry was spread over the surface of a 10 cm×10 cm×0.3 cm compression mold. The mold was closed and placed in a heated press to cure the thermoset polymer. Molding was conducted for 20 minutes at a temperature of 160° C. and a plate pressure of 35 MPa.

The polyolefin thermoplastic elastomer (Santoprene) compositions were blended using a 42 mm diameter counter rotating twin screw extruder (C.W. Brabender Type D-51). The materials were extruded into continuous stands using a 3 mm rod die. Extrusion was conducted at 30 RPM and extruder temperatures of 120° C. at the first zone closest to the resin feeder, followed by temperatures of 169° C., and 160° C. in the extruder barrel zone, and 156° C. at the die. After cooling down to around room temperature, the strands were pelletized using a Honeywell machine. Pellets were then compression molded at a temperature of 190° C. for 5 minutes and at a pressure of 35 MPa, using the same mold used for preparing the silicone composite plates.

### Electrical Conductivity Measurements

A four-point probe set-up measures the bulk (in-plane) electrical resistivity of a bipolar plate In order to determine the interfacial resistance, especially the one between the bipolar plate and gas diffusion layer, an experimental setup which can measure the through-plane resistance is used.

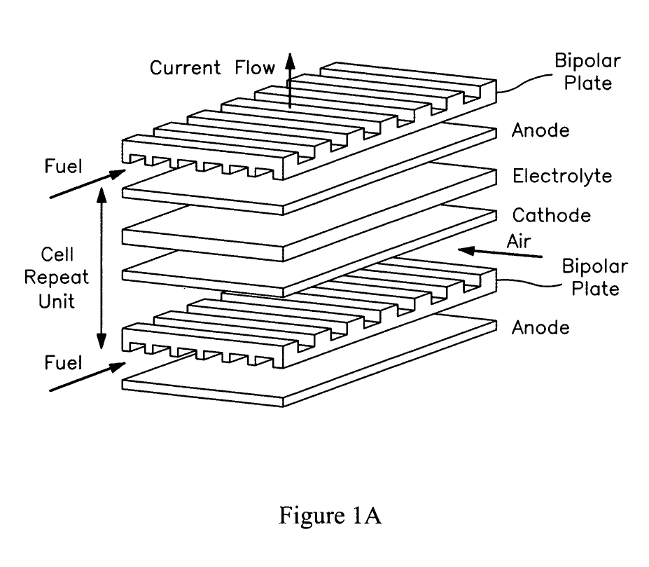

In 1958, Smits, F. M. developed a method for measuring the sheet resistivity with a four-point probe. The four-point probe measures the resistance between two contact points on the plate's surface. FIG. 2 shows a schematic of the setup. Two inner probes measure the voltage, while two outer probes measure the current.

The dimensions of the bipolar plate affect the resistance readouts. To account for this, two correction factors are used to find the actual electrical resistance of the composition, which also allows for direct comparisons of compositions. Equation 1 is used to calculate the sheet resistance and/or electrical resistivity.

Sheet Resistance(Rₛ)=ρ/t=(V/I)×CF₁×CF₂ (1)

Where ρ is resistivity, t is sample thickness; CF₁ and CF₂ are two correction factors, which account for the width (D), length, and thickness (t) of sample relative to probe spacing (s).

### Example 1

Preliminary measurements of conductivity of composites based on silicone rubber matrices and thermoplastic polyolefin matrices were carried out. The conductive filler was short length graphite fiber (DKD) Conductivity was measured for several filler/matrix concentration ratios. In the case of silicone elastomer low electrical resistivity of 0.327 Ω-cm was measured at low conductive filler concentration of 25% by volume. This is an unexpected low value of resistivity not normally obtainable in other polymer matrices at this low conductive filler content. Even lower resistivity values are obtained using the silicone elastomer matrix and higher filler concentrations of 30-40% by volume as seen in Table 3.

TABLE 3
Electrical resistivity of composites of silicone
rubber and graphite fiber (DKD)

| | % Conductive Filler of | Electrical Resistivity |
|---|---|---|
| Formulation No. | Graphite DKD | (Ω-cm) |
| 1 | 0 | — |
| 2 | 25 | 0.3271 |
| 3 | 30 | 0.08550 |
| 4 | 35 | 0.0571 |
| 5 | 40 | 0.0574 |

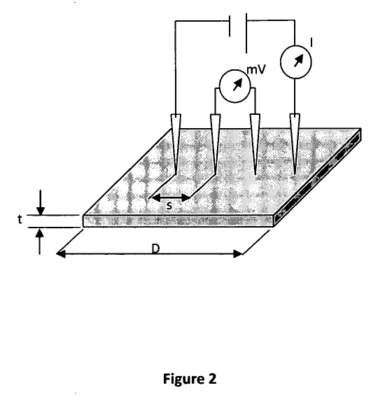

On the other hand the resistivity of composites based on polyolefin thermoplastic elastomer (Santoprene) remained high (>1000 ohm-cm) even for a composites containing 40% by volume graphite fiber DKD (FIG. 3). The resistivity of composites containing 35% or less of graphite fiber is over one million ohm-cm. In addition to high resistivity very high viscosity is measured for the composite containing 40% by volume filler, making the composite very difficult to process.

The above results on Santoprene are similar to other plastic conductive composites discussed in the literature, and highlight the unexpected low resistivity values we were able to accomplish for silicone conductive filler composites.

### Example 2

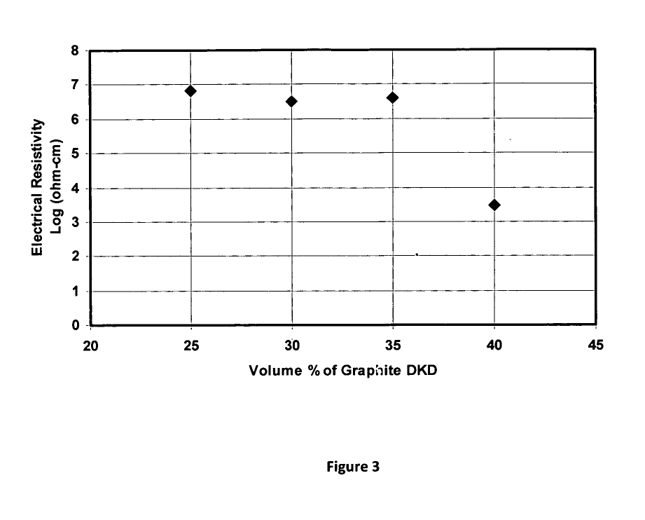

Conductivity measurements were carried out using other conductive additives and blends of these additives. FIG. 4 shows the results on resistivity of silicone/graphite fiber composites. Two types of fiber were used, a long fiber (CKD) and a short fiber (DKD). The graph shows an expected trend of resistivity versus concentration. Both fibers seem to be very effective in reducing resistivity. There seems to be a slight advantage of using the long fiber for reducing resistivity.

Composites were prepared using two mixing techniques for incorporating the fiber into the matrix: namely hand mixing and electric blender mixing. Again both methods are as effective in getting well mixed samples.

### Example 3

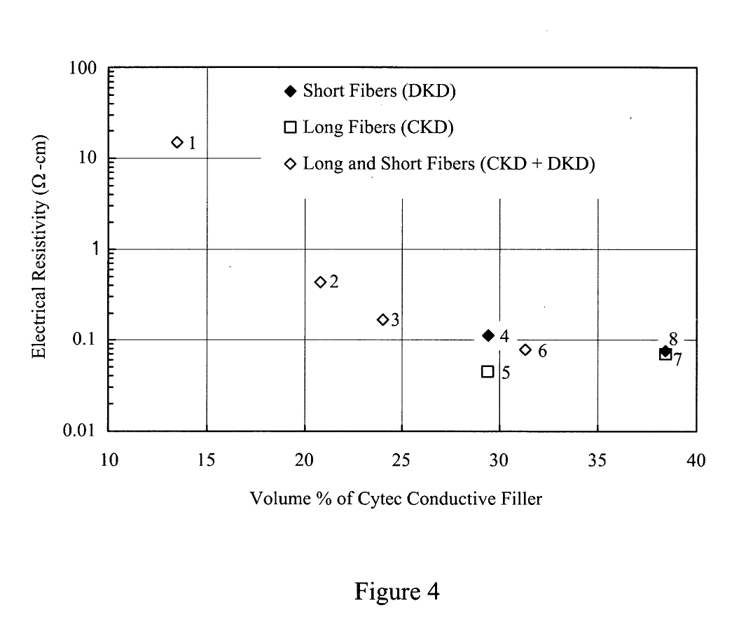

Comparison of resistivity obtained from silicone elastomer composites containing different fibers, flakes, or powders at concentration levels between 25 and 40 percent by volume are shown in FIG. 5. Similar trends for decrease of electrical resistivity with filler concentrations are observed. As seen in FIG. 5 all additives were effective in reducing electrical resistivity. The most effective fillers in reducing resistivity are the fibers. These are followed by synthetic flakes (Asbury 4012), and synthetic thermally conductive powder (TC 305).

### Example 4

### Synergy Effect of Two Conductive Fillers in Silicone Matrix Composition

For this series of experiments Cytec Thermal Graphite Fiber DKD was used as the main conductive filler, being most effective in reducing electrical resistivity among all fillers investigated. The resistivity of a composite containing 35 volume percent DKD is 0.0571 Ω-cm. New compositions were made with a 35 percent volume of conductive filler consisting of 28 volume percent DKD and 7 volume percent of a different conductive filler in the Silicone matrix. Blends of DKD containing either of two grades in flake form (grades 4012 and 3775), or one fiber (AGM 99) achieved lower resistivity than pure DKD. Compositions containing powder grades of graphite gave higher resistivity than pure DKD.

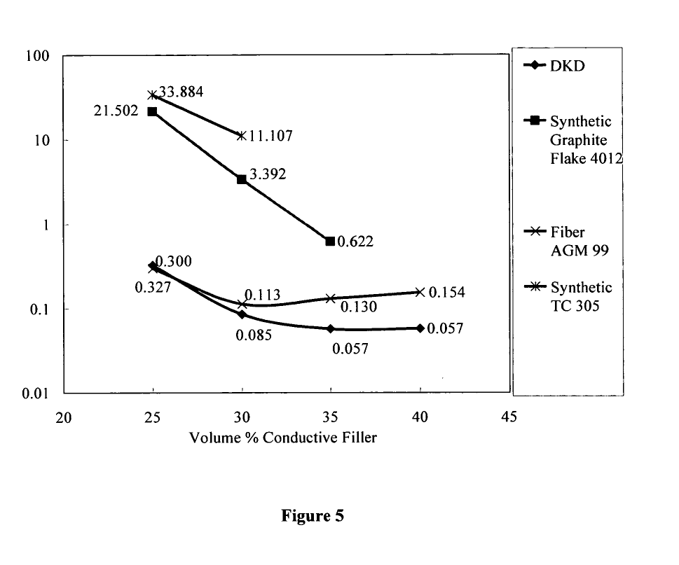

The data on the aforementioned blends of graphite fiber DKD and flake graphite or fibrous graphite demonstrates synergy effects. The resistivity obtained from individual graphite grades is higher than that obtained from the blends of graphite DKD and the flake or fibrous graphite (FIG. 6).

### Example 5

This example demonstrates that the elasticity of silicone-conductive filler composites maintain elastic characteristics. Maintaining elastic behavior of the elastomer containing conductive filler is important for a bipolar plate in order to maintain improved sealing of fuel cell reactants and reaction products, and for maintaining improved contact resistance. To evaluate whether or not the two elastomer systems maintain good elasticity after addition of fillers, cyclic compression testing was conducted to evaluate changes in compression modulus, and compression set as a function of filler contents.

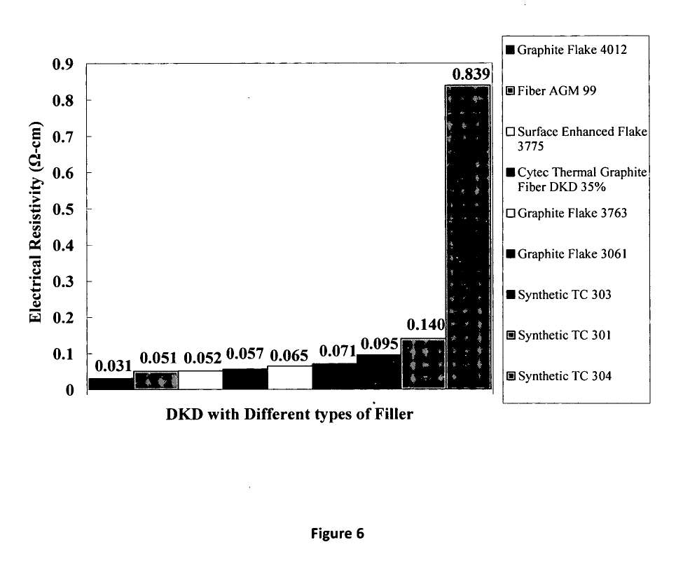

The stress strain curves of silicone rubber matrix and a composite containing 40% by volume graphite fiber (Cytec DKD) are shown in FIGS. 6 and 7. The curves show that compressing the samples through 25% of their original thickness and then unloading the stress results in almost complete recovery of the sample to its original thickness. This shows good elastic behavior for both pure rubber matrix and composites containing high graphite fiber content (40%). Using the curves the compression modulus was calculated of all composites of silicone rubber. The results are shown in Table 4. The table also shows compression set values for all materials calculated using the thickness of samples before and after compression testing. All values are average of triplicate runs. Low modulus values and low compression set values for the pure matrix and the composites indicate that the materials maintain good elastic behavior and should provide low electrical contact resistance and good sealing at low pressure.

TABLE 4
Compression modulus and compression set of
silicone rubber and silicone composites containing graphite
fiber

| Silicone/ | Compression | Compression |
|---|---|---|
| Graphite Fiber | Set (%) | Modulus (MPa) |
| 100/0 | 1.6 | 23.35 |
| 75/25 | 2.0 | 19.07 |
| 70/30 | 3.9 | 30.47 |
| 65/35 | 3.6 | 25.56 |
| 62/38 | 6.3 | 23.79 |
| 60/40 | 4.4 | 12.92 |

### Example 6

### Material Selection

A composite material consists of matrix material and conductivity fillers. The material attributes of each component play a crucial role in achieving desirable requirements for the bipolar plates. Different properties of each component in composite material will be explained in greater detail.

Elastomeric Material

The matrix material used in this investigation was a two-component silicone slurry (RTV 627 Momentive). Selected properties of this matrix are listed in Table 5. The silicone elastomer is a vinyl polydimethyl siloxane containing dimethyl hydrogen siloxane as the curvative. This silicone is known as a RTV meaning that it can be cured either at room temperature or higher temperature for accelerated curing time. Silicone's exceptional thermal stability, wide range of usage temperature, and very little degradation under exposure to fuel cell reactant gases make it a good candidate for a bipolar plate matrix material [24]. Another advantage of using Silicone over using other elastomers is that it does not require the addition of plasticizers to soften the material for more flexibility [13].

TABLE 5
Select Properties of Silicone

| Property | Published Value [12] |
|---|---|
| Density (g/cm³) | 1.37 |
| Electrical Resistivity (Ω-cm) | 5.7 × 10¹⁴ |
| Thermal Conductivity (W/m-K) | 0.31 |
| Hardness, Shore A | 62 |
| Tensile Strength (MPa) | 3.24 |
| Tear Strength (kN/m) | 3.33 |

Conductive Fillers

In order to make the composition electrically conductive, conductive fillers were added to the matrix material. Table 6 summarizes the properties of graphite fibers and flakes used in this investigation as conductive fillers. These conductive fillers are from the companies Asbury Carbons and Cytec Industries Inc. [17, 25]. Graphite fibers provide more linkages and strength to the composition, which is attributed to the fact that graphite fibers have good structure orientation of the strand-like shape [17]. The graphite fiber type used in this investigation was Cytec Thermal Graph DKD.

Graphite flakes have the advantage of processing well due to their high crystallinity and low springback. The overall size of these flakes is also determined by the processing conditions. The graphite flakes used in this research was synthetic 4012 flake from Asbury Carbons [17].

TABLE 6
Select Properties of Conductive Fillers
Investigated

Conductive Filler

| | Cytec Graphite | Asbury Synthetic 4012 |
|---|---|---|
| Property | DKD Fiber [25] | Graphite [17] |
| Density (g/cm³) | 2.2 | 2.23 |
| Electrical | <3 × 10⁻⁴ | 0.03 |
| Resistivity | | |
| (Ω-cm) | | |
| Thermal | 400-700 | — |
| Conductivity | | |
| (W/m-K) | | |
| Diameter (μm) | 10 | 50-800 |
| Length (μm) | 200 | 150 |
| Surface Area | 0.4 | 1.5 |
| (m²/g) | | |

### Manufacturing Samples

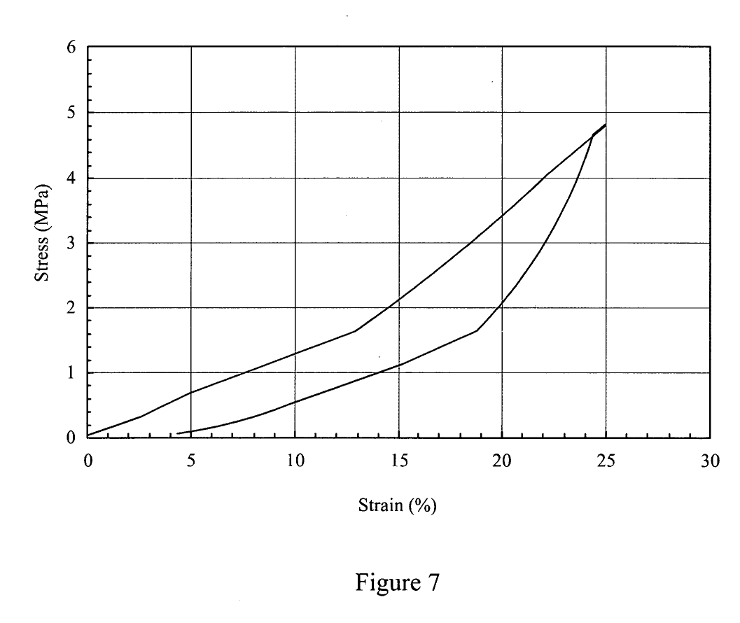

To make a composite material, each composition consists of a matrix and at least one conductive filler component. All compositions were formed into 10×10×0.3 cm sheets to provide a sufficient amount of sample material to be used for further testing. The two-component silicone slurry was firstly hand mixed and followed by additional mixing to incorporate the conductive fillers. Then the mixed composition was placed in the compression mold under a pressure of 35 MPa for 20 minutes at temperature of 160° C. to insure that the curing process was completed for the silicone. FIG. 8 shows the systematic approach to making the elastomeric bipolar plate samples. The amount of conductive filler used in each composition is 35% of the total composition.

### Material Property Testing

Once the compositions were made using a heated compression mold, several material properties were tested to draw conclusions about each composition. The rest of this example focuses on measuring electrical resistivity, thermal conductivity, and compression modulus of the compositions.

The electrical resistivity were measured using a four-point probe setup [26] that was connected to a data acquisition system to record resistance. Correction factors were then applied to consider the effects of sample shapes.

It is important for bipolar plate material to have good thermal conductivity to promote the transfer of energy between active and cooling cells in a fuel cell stack assembly [26]. Since the elastomeric matrix material is an insulating material, it is crucial to determine whether the conductive fillers help achieve the required thermal conductivity of 10 W/(m-K) set by the DOE.

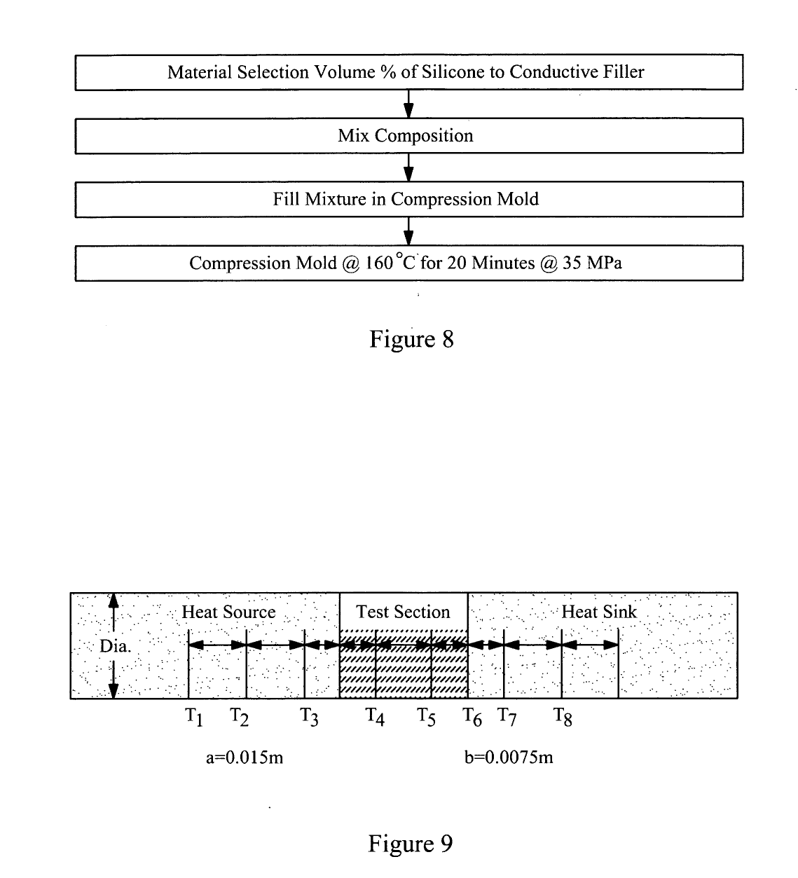

A Linear Conduction and a Data Acquisition unit (HT10X) were utilized to measure thermal conductivity for each sample. The linear conduction unit was set to test the samples under the conditions of a 10.6 W power supply and an air flow of 6 SCFM. Once there was no change in the temperature difference between the two probes (probes 4 and 5) placed in the sample, the system was known to be at steady state. Results were recorded to calculate for the heat transfer rate and the thermal conductivity. The symbolic representation of the unit is shown in FIG. 9.

The thermal conductivity of the tested sample was calculated using equation (1).

$$k = \frac{- {q}_{x}}{A ( \frac{{T}_{4} - {T}_{5}}{a} )} = \frac{- {q}_{x}}{{π ( \frac{D}{2} )}^{2} ( \frac{{T}_{4} - {T}_{5}}{a} )} \qquad ( 1 )$$

where q, is heat transfer rate (W), D is the diameter of the sample (m), T₄−T₅ is the temperature difference between points 4 and 5 (K), and ‘a’ is the spacing between thermocouples 4 and 5 (m), within the test section of the apparatus as seen FIG. 9.

To insure that the newly developed composite material can withstand enough compressive force when assembled into a fuel cell stack, each sample was tested using a universal MTS machine (MTS Q Test/50LP). One sample at a time was loaded between two compression platens. The Testworks 4 software was utilized that allows for a two endpoint compression method test to be carried out. Each sample was compressed to a maximum of 20 percent strain with a compression speed of 0.05 in/min. Once this maximum of 20 percent strain was exerted on each sample, then it was released at a speed of 0.05 in/min until there was no longer a force being applied to the sample. To determine elastic recovery of each sample, loading was repeated numerous of times until it appears that there was very little change in the stress-strain relationship. Between each cycle there was a 1 minute material relaxing time. By understanding the stress-strain relationship the compression set percent and modulus can be found. When a low value for the compression set percent and modulus is achieved the sample is said to have good elastic behavior, low deformation resistance, and high sealing capabilities.

### Results and Discussion

Based on our previous investigation, an optimal composite composition has a filler concentration of 35% and matrix concentration of 65% by volume. The same percentage of composition was used in this investigation. The only difference between the new sample and the earlier sample is that the conductive fillers in the new sample include both graphite fibers (Cytec DKD) and graphite flakes (4012) while graphite fibers are the only conductive fillers in the earlier sample. For the graphite fillers in the new sample, the composition of graphite fibers increases from 0% to 100% by volume while the composition of graphite flakes decreases from 100% to 0%.

### Electrical Resistivity

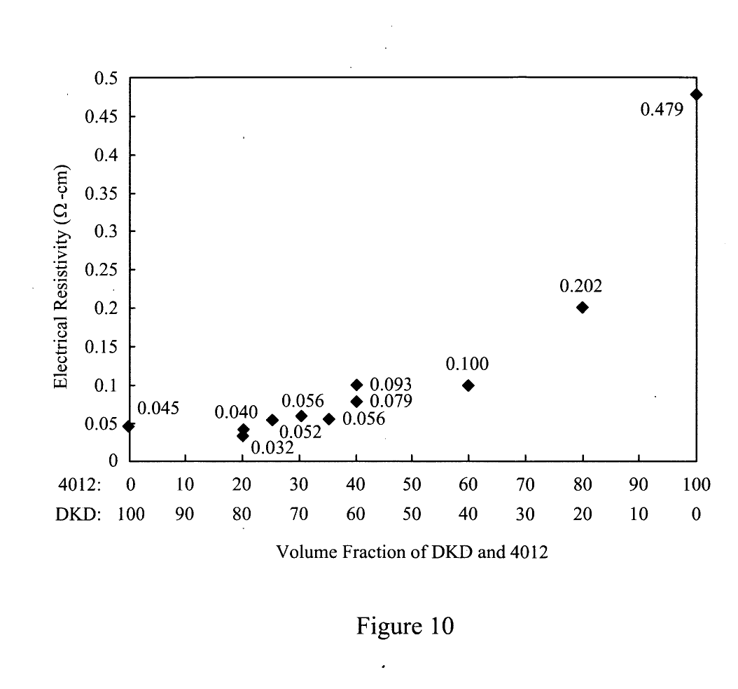

FIG. 10 shows the electrical resistivity of composites containing a 35% by volume of blends of Cytec DKD and Synthetic flake 4012. A full range investigation was conducted on varying the ratios of these two conductive fillers for a total of 35% volume within the matrix material. When the Cytec DKD was used alone, a relatively low electrical resistivity of 0.045 Ω-cm was observed while a relatively high electrical resistivity of 0.479 Ω-cm was found when the Synthetic flake 4012 was used alone.

However, when two fillers were blended together, the samples resulted in lower electrical resistivities than using one type of conductive filler alone within the silicone slurry matrix. This result shows that synergistic effects are present between the two fillers in reducing electrical resistivity. The best synergistic effect was observed when the composition consisted of 7% and 28% volume of 4012 and DKD, within the two component silicone slurry where an electrical resistivity of 0.032 Ω-cm was found. This indicates that there must be an interaction between the conductive fillers and the matrix material in this composition, which is not present or ideal in the other compositions.

### Thermal Conductivity

Since the composites consisting of Cytec DKD and Synthetic Flake 4012, within the two component silicone slurry matrix achieved promising electrical resistivity, it became important to verify whether the thermal conductivity meets the requirement of 10 W/m-K by DOE. FIG. 4 includes the spectrum of ratios of 35% volume between 4012 and DKD. When synthetic flake 4012 and Cytec DKD fiber were together in the compositions the thermal conductivity requirement were surpassed. Thete was one outlier at a concentration of 14% and 21% volume of 4012 and DKD, respectively. This is believed to have occurred due to processing conditions, leading to further investigation on how processing conditions affect the samples. Clearly all compositions consisting of a combination of these two conductive fillers achieved reasonable thermal conductivities as bipolar plate materials.

### Compression Modulus

In order to determine whether each sample maintains good elastic behavior, compression modulus test were performed. Table 7 includes the compression set and moduli obtained for disc samples with a 0.75 in diameter and a thickness of approximately 0.13 in. Data was obtained using a Universal MTS Machine described in the experimental section.

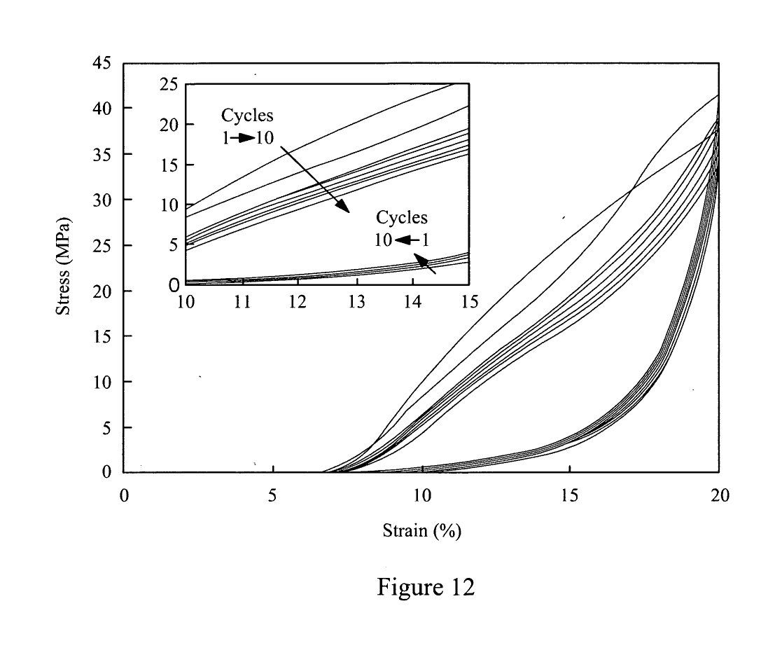

Load cycling was performed between 0 and 20% strain. The stress-strain curves of one of the conductive composite sample are shown in FIG. 12. The curves obtained during the loading part of the cycle show higher stress for the first two cycles than the subsequent 8 cycles. This is attributed to quasi-stable bonding between the filler and the rubber matrix that are broken upon applying stress to the sample. The phenomenon is known as the Mullin's effect.

The secant modulus of elasticity for the different samples was calculated from the loading curves for a strain region between 10 & 15%. The data is shown in Table 7. In general the modulus increases with the increase in the fiber to flake ratio of the conductive filler. Scatter in the calculated data can be attributed to the shape factor of the samples, making thicker samples appear to be softer and hence have lower calculated modulus.

Compression set data, shown in Table 7 was calculated from the difference between original thicknesses of samples and thicknesses after the loading and undergoing cycling. Very low compression set values 2 and 4% are measured, again demonstrating the high elastic characteristics of the composites.

TABLE 7
Properties of Elastomeric Compositions

| | Compression | Compression |
|---|---|---|
| Composition Volume % | Set % | Modulus (MPa) |
| 4012-35% | 2 | 197 |
| DKD-4012-7-28% | 2 | 242 |
| DKD-4012-14-21% | 3 | 315 |
| DKD-4012-21-14% | 3 | 304 |
| DKD-4012-28-7% | 4 | 280 |
| DKD-35% | 4 | 326 |

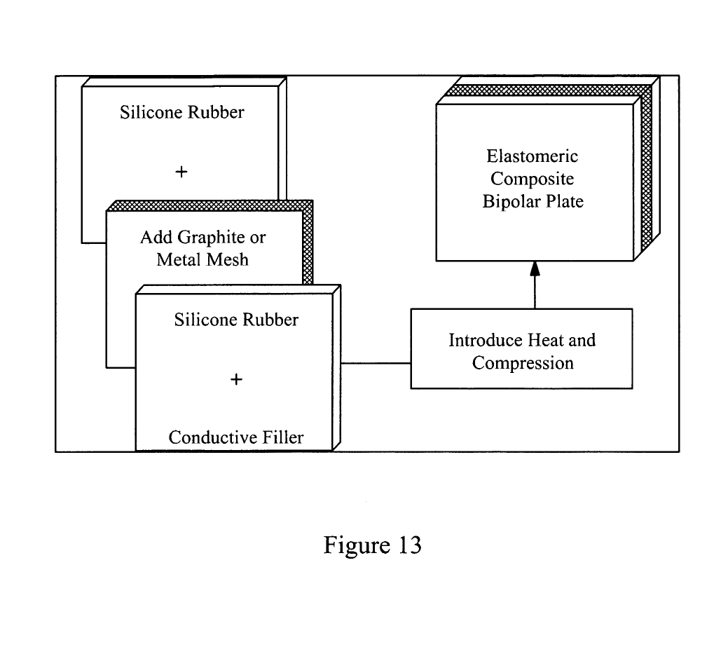

In spite of the excellent electrical conductivity, thermal conductivity, and elastomeric characteristics of the silicone/conductive filler materials developed in this investigation, their use as bipolar plate requires improvements in mechanical strength and the stiffness of these composites. One approach to accomplish this is to sandwich a layer of graphite or metal mesh or film between two layers of the conductive silicone rubber composites as seen in FIG. 13. Other options of consideration are to use different types of matrix materials along with the silicone slurry material. Both approaches are currently under investigation.

### CONCLUSION

A new elastomeric composite material was investigated for bipolar plates iri PEM fuel cells. To make the composite material, a two component silicone slurry was used as matrix with Cytec DKD fibers and synthetic flakes (4012) as conductive fillers. Low electrical resistivity was achieved at a filler concentration of 40% by volume or less. The synergy effect between graphite fibers and flakes was observed where lower resistivity was found for the composition consisting of a blend ratio of 28% and 7% for DKD graphite fiber and synthetic flakes (4012). Furthermore, both thermal conductivity and compression modulus were measured for the composite material developed in this research. The thermal conductivity of new material has a value of above 10 W/m-K, which meets the requirement set by DOE. Based on the measured compression modulus data, the strength of the silicone rubber based composite material could be reinforced before placed in a fuel cell to be used for a bipolar plate. This could be achieved by either adding a metal mesh or using a different matrix material.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

### REFERENCES

1. Yen, C-Y., Liao, S-H., Lin, Y-F., Hung, C-H., Lin, Y-Y., and Ma, C-C M., 2006, Preparation and Properties of High Performance Nanocomposite Bipolar Plate for Fuel Cell, J. Power Sources.
2. Kuan, H-C., Ma, M. C-C., Chen, K. H., and Chen, S-M., 2004, Preparation, Electrical, Mechanical and Thermal Properties of Composite Bipolar Plate for a Fuel Cell, J. Power Sources. 134, pp. 7-17.
3. Besmann, T. M., Klett, J. W., Henry Jr., J. J., and Lara-Curzio, E., 2001, Carbon/Carbon Composite Bipolar Plate for PEM Fuel Cells, SAE Inc. 02Fcc-14.
4. Müller, A., Kauranen, P., Von Ganski, A., and Hell, B., 2006, Injection Moulding of Graphite Composite Bipolar Plates, J. Power Sources. 154, pp. 467-471.
5. Mighri, F., Huneault, M. A., and Champagne, M. F., 2004, Electrically Conductive Thermoplastic Blends for Injection and Compression Molding of Bipolar Plates in the Fuel Cell Application, Polymer Engineering and Science, 44(9), pp. 1755-1765.
6. Wu, M., and Shaw, L., 2005, Electrical and Mechanical Behaviors of Carbon Nanotube-Filled Polymer Blends, Wiley InterScience.
7. Greenberg, E. R., May, M. N., Wise, J., and Gadala-Maria, F., 2005, Effect of Shear on the Electrical Conductivity of Suspensions of Graphite in an Unsaturated Polyester Resin, Polymer Engineering and Science. Pp. 1540-1545.
8. Huang, J., Baird, D. G., and McGrath, J. E. 2005, Development of Fuel Cell Bipolar Plates from Graphite Filled Wet-Lay Thermoplastic Composite Materials, J. Power Sources. 150, pp. 110-119.
9. Hermann, A., Chaudhuri, T., and Spagnol, P., 2005, Bipolar Plates for PEM Fuel Cells: A Review, Inter. J. Hydrogen Energy. Pp. 1297-1302.
10. Mehta, V., and Cooper, J. S., 2003, Review and Analysis of PEM Fuel Cell Design and Manufacturing, J. Power Sources. 114, pp. 32-53.
11. Bin, Z., Bingchu, M., Chunhui, S., and Runzhang, Y., 2006, Study on the electrical and Mechanical Properties of Polyvinylidene Fluoride/Titanium Silicon Carbide Composite Bipolar Plates, J. Power Sources. 161(2), pp. 997-1001.
12. GE Silicone Technical Data, 2007, www.gesilicones.com.
13. Strong, B. A., 2006, Plastics Materials and Processing. Prentice Hall.
14. Advanced Elastomer Systems (Division of ExxonMobil Chemical) Technical Data, 2007, www.santoprene.com
15. Cabot Corporation. (2007). http://w1.cabot-corp.com/index.jsp.
16. Evonik Industries. (2007). http://www.degussa.com/.
17. Tamashausky, A. Asbury Carbons. (2007). http://www.asbury.com/.
18. Sánchez-González, J., Macias-García, A., Alexandre-Franco, M. F. & V. Gómez-Serrano (2005). Electrical conductivity of carbon blacks under compression. Carbon. 43(4), 741-747.
19. Kelly, C. J. N. (1982). Electrically conductive composition. U.S. Pat. No. 4,327,480. http://www.freepatentsonline.com/4327480.html.
20. Vieltich, W, Gasteiger, H. A. and Lamm, A., 2003, “Handbook of Fuel Cells—Fundamentals, Technology and Applications,” John Wiley & Sons, Ltd.
21. The Hydrogen Pathway, 2005, “Innovative Concepts for Bipolar Plates,” CLEFS CE, 50/51, pp. 76-89.
22. Jousse, F., Salas, J. F., Giroud, F., Icard B., Laurent, J. Y., and Serre Combe, P., 2000, “Development of New Bi-Polar Plates Based on Electrically Conductive Filled Polymers for PEMFC,” EUROMAT 99.
23. Hudak, G. A., 2005, “Fuel Cell Technology and Its Importance to Society,” Tech Directions.
24. Frisch, L., 2001, “PEM Fuel Cell Stack Sealing Using Silicone Elastomers,” Sealing Technology, 93. pp. 7-9.
25. Cytec Industries Inc., 2007, http://www.cytec.com/.
26. Barbir, F., 2005, “PEM Fuel Cells: Theory and Practice,” New York: Elsevier Inc.

We claim:

1. An elastomeric highly conductive composite of an elastomeric matrix and conductive fillers for use as bipolar plates for a proton exchange membrane (PEM) fuel cell, and which function to manage the flow of reactant gases through the fuel cells, wherein the elastomeric bipolar plates provide sealing to contain fuel cell reactant fluids and reaction by-products without the need for additional gaskets and low contact electrical resistance.

2. The composites of claim 1 wherein the elastomeric matrix is silicone rubber.

3. The composites of claim 2 where the elastomeric matrix contains silica filler.

4. The composite of claim 1 wherein the conductive filler is selected from the group consisting of graphite fiber, natural graphite flakes, synthetic graphite flakes, graphite powder, and mixtures thereof.

5. The composite of claim 1 wherein 15 to 60 volume percent conductive filler is uniformly distributed in the elastomeric matrix.

6. The composite of any one of claims 1, 2, 3 or 4, comprising between 25 to 40 volume percent conductive filler and 60 to 75 volume percent silicone rubber matrix.

7. The composite of any one of claims 1, 2, 3 or 4, wherein the conductive filler is a blend of a graphite fiber and graphite flake.

8. The composite of claim 1 comprising graphite fiber and graphite flake providing improved electrical resistivity over the fiber or flake alone.

9. The composite of any one of claims 1, 2, 3 or 4, wherein the conductive filler concentration is between 15 to 60% volume percent.

10. The composite of any one of claims 1, 2, 3 or 4, wherein the conductive filler is between 20 and 35 volume percent.

11. The composite of any one of claims 1, 2, 3 or 4, wherein silicone matrix content is between 60 and 75% by volume.

12. A proton exchange membrane (PEM) fuel cell assembly which comprises bipolar plates for the fuel cell, the plates comprising 15 to 60 volume percent conductive filler, comprising carbon based fibers, carbon based flakes, or a mixture of carbon based fibers and carbon based flakes and the balance an elastomeric matrix.

13. The assembly of claim 12 comprising 60 to 80 volume percent of the matrix for the filler which is homogeneously dispersed throughout the matrix.

14. The assembly of claim 12 wherein the matrix is a silicone elastomer, so that the plate is elastic.

15. The assembly of any one of claims 12, 13, or 14, wherein the volume percent of the conductive filler is 20 to 40 volume percent.

16. The assembly of any one of claims 12, 13 or 14, wherein the matrix contains a non conductive filler in an amount of 35% by volume.

17. The assembly of any one of claims 12, 13 or 14, wherein the matrix contains silica as a filler in an amount of 35% by volume.

18. The assembly of claim 12 wherein a porous heat sink is provided on the bipolar plate to dissipate heat.
